(19) United States
(12) Patent Application Publication
(10) Pub. No.: US 2007/0199767 A1
(43) Pub. Date: Aug. 30, 2007

(54) Tactical safety belt

(76) Inventor: David P. Altieri, Woodland Park, CO (US)

Correspondence Address: HANES & SCHUTZ, LLC, 102 SOUTH TEJON ST., SUITE 800, COLORADO SPRINGS, CO, 80903, US

(21) Appl. No.: 11/363,467

(22) Filed: Feb. 28, 2006

(51) Int. Cl. A62B 35/00; A62B 1/16

(52) U.S. Cl. 182/3

(57) ABSTRACT

The present invention relates to a tactical safety belt comprising an elongated strip of flexible belt material having first and second ends, where the first end is folded back upon itself to form a buckle receiving loop and an adjacent open sided pocket between the folded portions of the belting material. A buckle is affixed to the loop and adapted to receive the second end of the belt material to secure the belt around the waist of the user. A ring is slidably secured within the pocket so that the ring may be stowed within the pocket or partially pulled from the pocket to be accessed for use in receiving a safety rope hook or an emergency rappelling line.

### BACKGROUND OF THE INVENTION

A tactical safety belt generally comprises a durable and strongly constructed waist belt having secured to the front side thereof a ring capable of receiving the hook end of a safety line or receiving emergency rappelling lines. Excluding the emergency-only rappelling option, the belts are most frequently used by military, police, fire fighting and construction personnel to secure a person against falling from the open door of an aircraft or from a position of risk on an elevated structure.

While carabineers are sometimes used, the ring of choice in most tactical safety belt applications is a triangularly shaped ring with an elongated slot on one side thereof that receives a length of webbing that attaches the triangular ring to the front of the waist belt. The ring is fastened to the belt so that it lies flat against the outside surface of the belting material, but because the ring has to be accessible to receive a hook or line, it must rotate about the axis of the elongated loop. When not in use for its intended purpose, the rotatable ring is free to flap and bounce on the belt. Because such movement is an undesirable irritant and also detracts from the exacting appearance of uniforms with which the belt is often worn, a means to tie down the free end of the ring is necessary. Securing the ring against undesirable movement is most often done with hook and loop material (“Velcro”) that temporarily binds the whole ring to the belt.

While lashing the ring to the belt with additional materials has been a satisfactory resolution to date, such a solution leaves much to be desired. The additional hook and loop material interferes with the desired functioning of the ring. The material does not present a clean appearance. The material wears out and loses its effectiveness. Furthermore, such material was never designed to be put through buckles. It is noisy and does not perform well in mud or sand. The normally lateral orientation of the triangular ring on the belt is not the most effective positioning of the ring.

Accordingly, it is the primary purpose of the present invention to provide a novel means to attach a ring to a tactical safety belt that will eliminate the need for any supplemental tie down apparatus to maintain the ring in a stable and confined position on the belt.

A second object of the invention is to provide an attachment mechanism between a belt and ring that will maintain the demanding and orderly appearance of military dress.

### SUMMARY OF THE INVENTION

The tactical safety belt of the present invention includes a traditional waist belt and a buckle. One end of the belting material is folded back upon itself to form a buckle receiving loop and an open sided pocket between the folded portions of the material. One side of a conventional buckle is attached into the loop while the other side of the buckle is adapted to receive the free end of the belting material to secure the belt around the waist of the wearer. A slotted slide ring is secured within the pocket located between the folded portions of the belting. The ring is slidably disposed on a loop of webbing secured within the pocket so that when not in use the ring may be pushed downwardly into the pocket and out of sight. To use the ring it is pulled upwardly out of the pocket where the open portion of the ring is exposed for easy access to a hook or line. The vertical orientation of the exposed ring is advantageous in reacting to the forces imposed on the belt by a safety line or rappelling line.

### DESCRIPTION OF THE DRAWINGS

FIG. 1 is a perspective view of the tactical safety belt of the present invention showing the attachment ring in its exposed position outside of the housing pocket formed by the folded back portion of the belt end.

FIG. 2 is an enlarged fragmentary view of the front central portion of the belt shown in FIG. 1.

FIG. 3 is similar to FIG. 2, but showing the attachment ring disposed within the housing pocket.

FIG. 4 is a cross sectional view of the belt taken along the lines 4-4 in FIG. 2.

### DETAILED DESCRIPTION OF PREFERRED EMBODIMENT

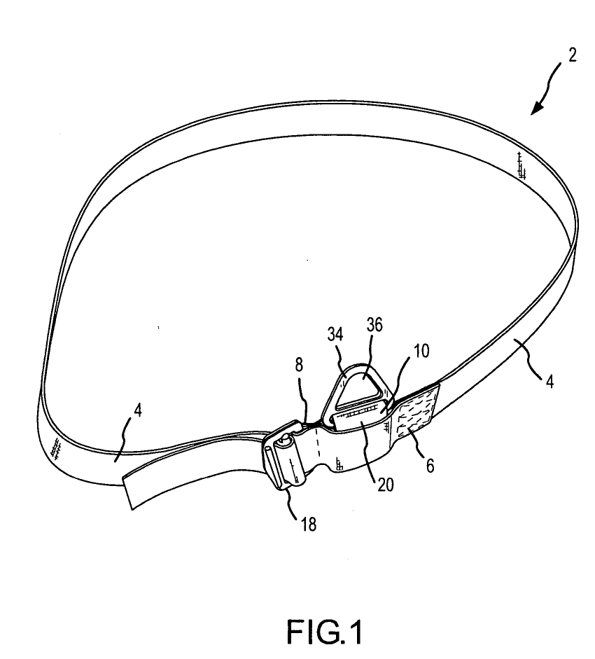

Referring to FIG. 1, the tactical safety belt 2 of the present invention is illustrated. An elongated strip of belting material 4 is adapted to surround the waist of the wearer in the traditional manner of a belt. One end 6 of the belting material is folded back on the belt and sewn or otherwise interconnected to the belt so as to form a buckle receiving loop 8 and an adjacent housing pocket 10. The loop 8 is formed by sewing across the width of the belt and the folded end 6 thereof. The housing pocket 10 is formed between the buckle loop stitching 12 and the stitching 14 that secures the terminal end of the folded back portion 6 to the body of the belting material 4. The pocket 10 is open on its top and bottom sides.

A conventional belt buckle 18 is attached to the belt through the buckle receiving loop 8. The free end of the belting material engages the buckle in a conventional manner to secure the belt around the waist of the wearer.

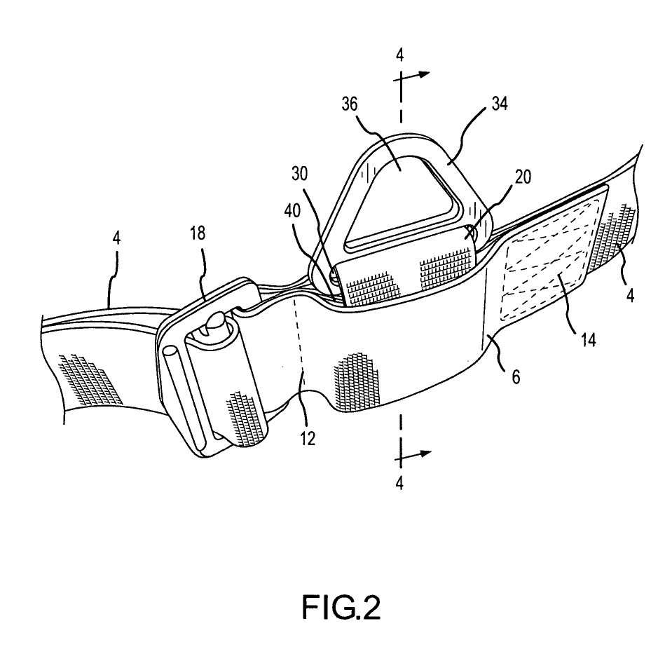

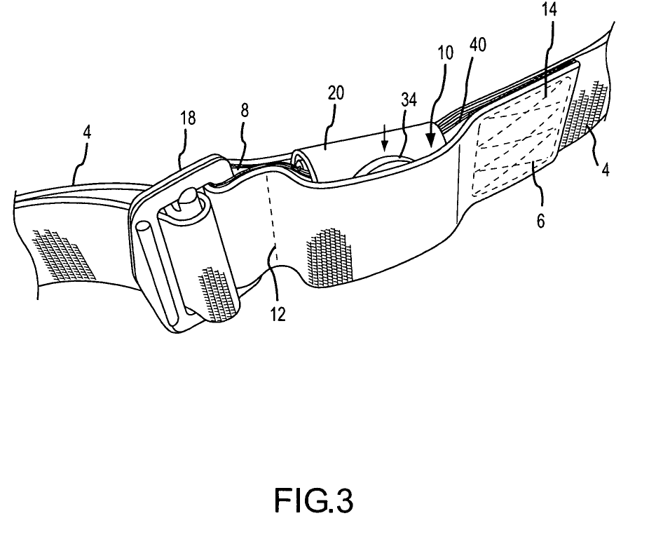

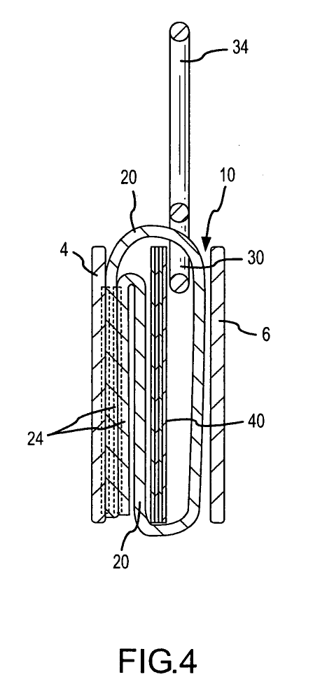

Within the pocket 10 and between the belt material 4 and the folded end 6, an interior ring anchoring device is formed by a loop of flexible webbing 20, as shown in FIG. 4. The terminal ends 24 of the loop are sewn or otherwise fastened to the interior side of the belting material 4. The webbing 20 has a width that fits within the pocket 10, as best seen in FIGS. 2 and 3. The width of the loop 20 is perpendicular to the circumference of the loop, which circumference is perpendicular to the longitudinal axis of the belting material 4. The webbing 20 is trained through the elongated slot 30 on the base side of a triangular slotted slide ring 34, the opposite open end 36 of which is adapted to receive the hook of a safety line or an emergency rappelling line. The width dimension of the loop webbing 20 is slightly less that the length of the ring slot 30 and the thickness of the webbing 20 is somewhat less that the width of the slot 30 in order to permit sliding movement of the upper and outside portions of the webbing loop 20 through the slot 30.

FIGS. 1, 2 and 4 illustrate the position of the ring 34 when it is pulled out of the pocket 10 and is available for use for its intended purposes. FIG. 3 illustrates the ring in its stowed position within the pocket 10 when it is not in use. All that is required to stow the ring 34 within the pocket 10 is to apply downward pressure on the ring so that it slides down the outside of the webbing loop 20. The main body of the ring 34 and is thereby positioned between the webbing 20 and the inside surface of the end portion 6 of the belt, as shown in FIG. 3. To expose the ring and ready it for use, the top corner of the ring is grasped and pulled upwardly so that the ring slides up the outside portion of the loop formed by webbing 20 to the top of the loop where it is firmly anchored.

To stiffen and strengthen the pocket 10 and eliminate the possibility of twisting of the belt when force is applied to the ring by a safety or rappelling line or deformation of the webbing loop which would inhibit quick storage of the ring, an additional strip of substantially rigid material 40 may be inserted between the folded portions of the belt, as best shown in FIG. 4.

What is claimed is:

1. A tactical safety belt comprising,
an elongated strip of flexible belt material having first and second ends where said first end is folded back upon itself to form a buckle receiving loop and an open sided pocket between the folded portions of the material,
a buckle affixed to the loop and adapted to receive the second end of the material, and
a ring slidably secured within the pocket.

2. The belt of claim 1 where the ring includes an elongated web receiving slot.

3. The belt of claim 2 and further including,
a closed loop of webbing secured within the open sided pocket, said webbing being slidably disposed within the web receiving slot of the ring.

4. The belt of claim 3 where the circumferential aspect of the closed loop of webbing is disposed perpendicularly to the longitudinal axis of the strip of belt material.

5. The belt of claim 4 and further including stiffening means traversing the interior of the closed loop of webbing and secured to the strip of belt material laterally of the open sided pocket.
